(19) United States
(12) Patent Application Publication
(10) Pub. No.: US 2013/0034654 A1
(43) Pub. Date: Feb. 7, 2013

(54) METHOD FOR MAKING AN OPTICAL FIBER PREFORM

(71) Applicants: Tetsuya Haruna, Yokohama-shi (JP); Masaaki Hirano, Yokohama-shi (JP); Yoshiaki Tamura, Yokohama-shi (JP)

(72) Inventors: Tetsuya Haruna, Yokohama-shi (JP); Masaaki Hirano, Yokohama-shi (JP); Yoshiaki Tamura, Yokohama-shi (JP)

(73) Assignee: SUMITOMO ELECTRIC INDUSTRIES, LTD., Osaka-shi (JP)

(21) Appl. No.: 13/557,248

(22) Filed: Jul. 25, 2012

(30) Foreign Application Priority Data
Aug. 1, 2011 (JP) 2011-168706

(51) Int. Cl. G02B 6/036

(52) U.S. Cl. 427/163.2

(57) ABSTRACT

A method for the manufacture of an optical fiber preform for producing a low attenuation optical fiber with high yield, comprising preparing a core rod and adding a cladding region. At the step of preparing a core rod, the core rod is produced including a first core region with Cl density of less than 600 atm-ppm, a second core region with Cl density of less than 600 atm-ppm around the first core region, and a third core region with Cl density of 3000 atm-ppm or more around the second core region. An alkali metal is selectively added to the first core region among the first, second, and third core regions. A cladding region is formed around the core rod by heating at a temperature of 1200° C. or higher for 7 hours or less.

### BACKGROUND OF THE INVENTION

1. Field of the Invention

The present invention relates to a method of manufacturing an optical fiber preform.

2. Description of the Background Art

An optical fiber made of silica glass in which an alkali metal is added to the core region is known (Japanese translation of PCT international applications No. 2005-537210, No. 2007-504080, No. 2008-536190, No. 2010-501894, No. 2009-541796, and No. 2010-526749, International Publication No. WO 98/002389, US Patent Application Publication 2006/0130530, and U.S. Pat. No. 5,146,534). In the case where an alkali metal is added to the core region of an optical fiber preform, the viscosity of the core region can be lowered when the optical fiber preform is drawn into a fiber, whereby the relaxation of network structure in the glass of the core region will progress. Therefore, it is said that the attenuation of an optical fiber can be lessened.

A diffusion method is known as a technique for adding an alkali metal into silica glass (e.g., Japanese translation of PCT international applications No. 2005-537210, and US Pat. App. Publication No. 2006/0130530). The diffusion method is a technique for conducting diffusion doping of alkali metals into the inner surface of a glass pipe such that while material vapors such as alkali metals or alkali metal salts which are used as materials are introduced into the glass pipe, the glass pipe is heated with an outside heating source or a plasma is generated in the glass pipe.

An alkali metal is added to the inner surface and neighboring portion of a glass pipe as mentioned above, and thereafter the glass pipe is subjected to diameter contraction by heating. After the diameter contraction, the inner surface of the glass pipe is etched by an appropriate thickness in order to remove transition metal elements, such as Ni, Fe, or the like, which have been inevitably added simultaneously when the alkali metal is added. Since an alkali metal exhibits quicker diffusion than the transition metal elements, it is possible to keep the alkali metal to remain even if the transition metal elements are removed by etching the glass surface at a certain thickness. Thus, a core rod to which an alkali-metal is added is prepared by heating and collapsing the glass pipe after etching. And an optical fiber preform is produced by forming a cladding part on the outside of the core rod to which the alkali-metal is added. Thus, an optical fiber can finally be manufactured by drawing the optical fiber preform into a fiber.

### SUMMARY OF THE INVENTION

The object of the present invention is to provide a method of manufacturing an optical fiber preform which is suitable for producing a low-attenuation optical fiber with high yield.

The method of the present invention for manufacturing an optical fiber preform having a core region including a central axis and a cladding region formed around the core region, in which the refractive index of the cladding region is lower than that of the core region, comprises: a step of preparing a core rod having a first core region with Cl density of less than 600 atm-ppm and including the central axis, a second core region with Cl density of less than 600 atm-ppm and formed around the first core region, and a third core region with Cl density of 3000 atm-ppm or more and formed around the second core region, wherein an alkali metal is selectively added to the first core region among the first, second, and third core regions; and a step of adding a cladding region around the core rod, wherein the cladding region is formed by heating at a temperature of not less than 1200° C. for 7 hours or less.

The ratio (d₂/d₁) of a diameter d₂ of the second core region to a diameter d₁ of the first core region is preferably 1.2 or more and 2.5 or less, and more preferably 1.5 or more and 2.5 or less. At the step of adding a cladding region, it is preferable to form the cladding region around a core rod by heating at a temperature of 1200° C. or more for one hour or less. At the step of adding a cladding region, it is preferable to form the cladding region around the core rod by inserting the core rod into a silica glass pipe, which is to become the cladding region, and integrating the core rod and the glass pipe into one unit.

According to the present invention, it is possible to manufacture a high yield optical fiber preform suitable for making an optical fiber that will exhibit a low attenuation.

### BRIEF DESCRIPTION OF THE DRAWINGS

FIG. 1 is a sectional view of an optical fiber preform produced by an embodiment of the present invention for manufacturing an optical fiber preform.

FIG. 2 is a conceptional schematic diagram illustrating the step of preparing a core rod in an embodiment of the invention for the method of manufacturing an optical fiber preform.

FIGS. 3A and 313 are conceptional schematic diagrams illustrating the step of adding a cladding region according to a soot deposition and consolidation method.

FIG. 4 is a conceptional schematic diagram illustrating the step of adding a cladding region by a rod-in-collapse method.

FIG. 5 is a graph indicating crystallization (or non-crystallization) under the respective conditions at the step of adding a cladding region.

FIG. 6 is a graph showing the relation between a ratio (d₂/d₁) and the attenuation of an optical fiber, where d₁ is the diameter of the first core region and d₂ is the diameter of the second core region.

FIG. 7 is a conceptional schematic diagram showing the refractive index profile of an optical fiber.

FIG. 8 is a conceptional schematic diagram showing other examples of refractive index profile of an optical fiber.

### DETAILED DESCRIPTION OF THE INVENTION

Hereinafter, preferred embodiments of the present invention will be described in reference to the accompanying drawings. The drawings are provided for the purpose of explaining the embodiments and are not intended to limit the scope of the invention. In the drawings, an identical mark represents the same element so that the repetition of explanation may be omitted. The dimensional ratios in the drawings are not always exact.

The inventor of the present application has found that letting an alkali metal and a Cl element to co-exist in a silica glass optical fiber is effective for lessening attenuation of the fiber. However, in the case where the alkali metal and the Cl element are both added to the core region of an optical fiber preform, air bubbles and crystals of alkali metal chloride will be generated in the silica glass. In the process of drawing the optical fiber preform into a fiber, such crystals of alkali metal chloride and air bubbles will cause breakage and fluctuation in the diameter of an optical fiber or locally degrade attenuation of an optical fiber, resulting in a factor of low yield in manufacture of optical fibers.

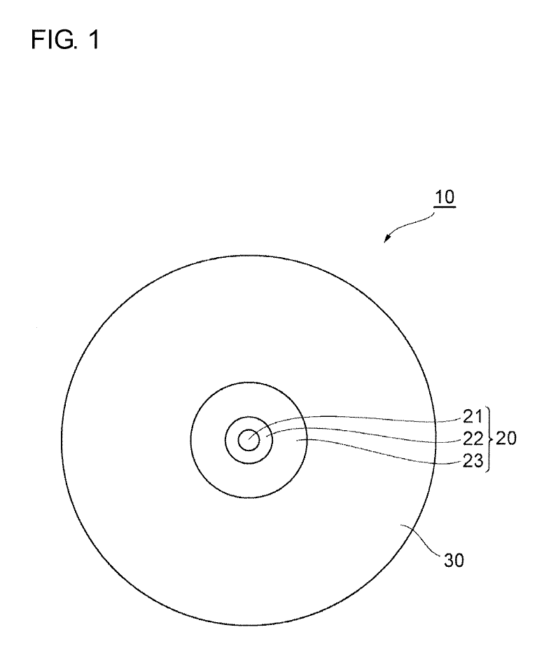

FIG. 1 is a sectional view of an optical fiber preform 10 produced by an embodiment of the present invention for manufacturing an optical fiber preform. The optical fiber preform 10 is made of silica glass and has a core region 20 including a central axis and a cladding region 30 provided around the core region 20. The cladding region 30 has a refractive index lower than that of the core region 20. The core region 20 has a first core region 21 including the central axis, a second core region 22 provided around the first core region 21, and a third core region 23 provided around the second core region 22.

The Cl densities of the first and second core regions 21 and 22 are respectively less than 600 atm-ppm. The Cl density of the third core region 23 is 3000 atm-ppm or more. An alkali metal is selectively added to the first core region 21 among the core regions 21, 22, and 23.

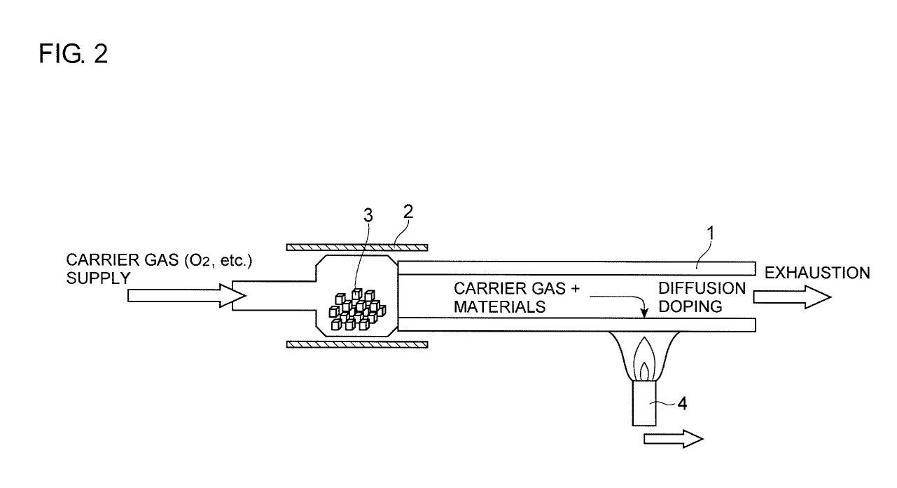

The method of this embodiment for manufacturing an optical fiber preform comprises: a step of preparing a core rod which is to become the core region 20; and a step of adding a cladding region 30 around the core rod. FIG. 2 is a conceptional schematic diagram illustrating the step of preparing a core rod in an embodiment of the invention for the method of manufacturing an optical fiber preform. A gas of alkali metal materials 3 which has been heated by a heat source 2 (an electric furnace, a burner, or the like) is supplied together with a carrier gas (O₂ gas, Ar gas, He gas, or the like) to the inside of a silica glass pipe 1 in which the Cl density is less than 600 atm-ppm. At the same time, the glass pipe 1 is heated by an outside heat source 4 (thermal plasma, oxy-hydrogen flame, or the like). Thus, the glass pipe 1 is doped with the alkali metals from the inner surface thereof.

After the diameter contraction of the glass pipe 1 is carried out by heating, transition metal elements such as Ni and Fe and OH group, which have been inevitably added simultaneously at the time of alkali metal doping, are removed by etching the inside surface of the glass pipe 1. Thus, a glass rod is prepared by collapsing the glass pipe 1. In a glass rod, the central part where the alkali metal has been added becomes a first core region 21. The transition metal elements and OH group existing in the outer surface are removed by grinding the surface of the glass rod 1 by a given quantity. Consequently, the peripheral portion of the glass rod 1 becomes a second core region 22 in which the alkali metal concentration and the chlorine concentration are both low.

A core glass rod which is to become the core region 20 is prepared by forming a third core region 23 around the glass rod 1. The third core region 23 is formed by synthesizing silica-based glass to which Cl elements of high concentration of 3000 atm-ppm or more are added (“soot deposition and consolidation method”). Or, the third core region 23 is formed by collapsing a silica-based glass pipe having Cl elements of high-concentration of 3000 atm-ppm or more (“rod-in collapse method”). An optical fiber preform 10 is fabricated by forming a cladding region 30 around the third core region 23.

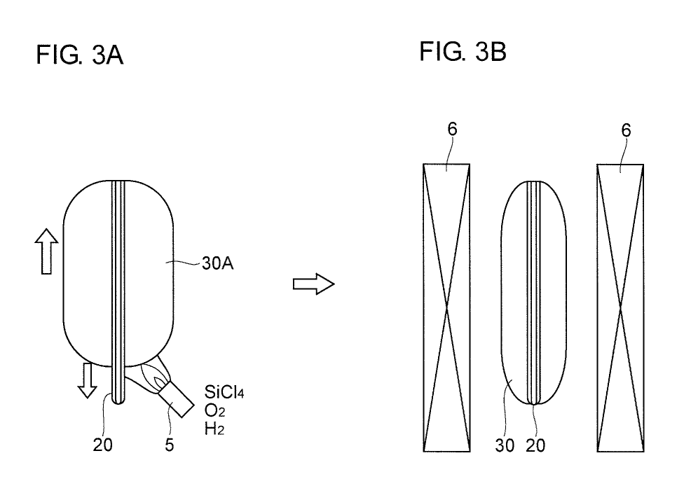

FIGS. 3A and 3B are conceptional schematic diagrams illustrating the step of adding a cladding region by a soot deposition and consolidation method. The soot deposition and consolidation method consists of a soot deposition process (FIG. 3A) and a consolidation process (FIG. 3B). In the soot deposition process, a glass soot body 30A is formed around the core rod 20 by blowing off a material gas and the like (SiCl₄, O₂, H₂) from a burner 5 with a method such as VAD, OVD, or the like. In the consolidation process, the glass soot body 30A is vitrified by heating with a heater 6 so as to make a cladding region 30. Thus, an optical fiber preform 10 is fabricated.

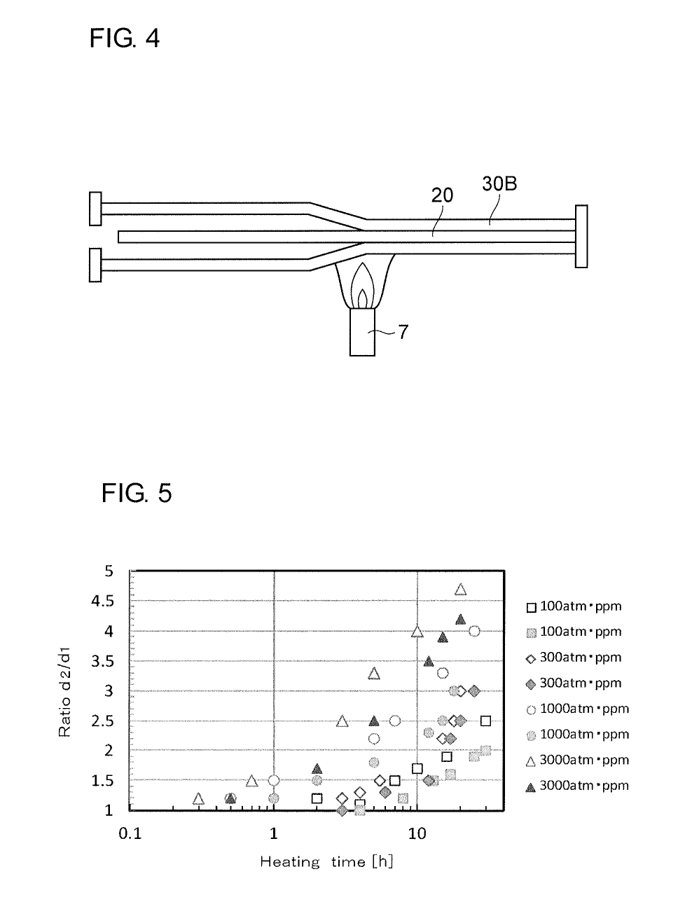

FIG. 4 is a conceptional schematic diagram illustrating the step of adding a cladding region by the rod-in-collapse method. In the rod-in-collapse method, a tubular material 30B which is to become a cladding region 30 is prepared, and the core rod 20 is inserted into the tubular material 30B, and the outside of the tubular material 30B is heated with a burner 7 so as to consolidate the core rod 20 and the tubular material 30B (collapsing), whereby an optical fiber preform 10 is fabricated.

The alkali metal added to the first core region 21 tends to diffuse so fast that the diffusion will spread in a wide range if the heating time is long. At the step of adding a cladding region, particularly at the consolidation process, in the soot deposition and consolidation method, generally it is necessary to conduct the heating at least for 8 hours or more at a temperature of not less than 1200° C. In such case, diffusion of alkali metals in the first core region 21 will progress, and consequently the alkali metals and Cl elements will react with each other at the interface between the second core region 22 having a low Cl density (<600 atm-ppm) and the third core region 23 having a high Cl density (>3000 atm-ppm), thereby generating salts which will cause crystallization and bubbles.

Hereinafter, the results of an experiment in which potassium as alkali metal was added to the first core region 21 will be explained. In this experiment, the Cl density of a glass pipe 1 (namely, the respective Cl density of the first core region 21 and the second core region 22) was 300 atm-ppm, whereas the Cl density of the third core region 23 was 10000 atm-ppm. An investigation was done as to occurrence (or non-occurrence) of crystallization at the interface between the second core region 22 and the third core region 23 in optical fiber preforms 10 produced under different conditions, by adopting various values for potassium density in the first core region 21, ratios (d₂/d₁) of the diameter d₂ of the second core region 22 to the diameter d₁ of the first core region 21, and heating time at temperatures of not less than 1200° C. in the step of adding a cladding region. Note that the larger the ratio (d₂/d₁), the thicker the low Cl density second core region 22 is. In the case where the heating time at a temperature of not less than 1200° C. was 8 hours or more, the soot deposition and consolidation method was adopted, whereas the rod-in-collapse method was adopted when the heating time was less than 8 hours.

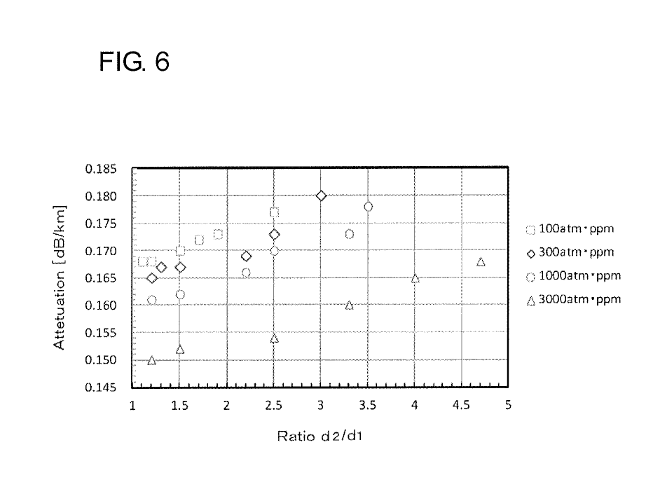

FIG. 5 is a graph indicating occurrence (or non-occurrence) of crystallization under the respective conditions at the step of adding a cladding region: hollow marks are results in the case of Examples and solid marks are results in the case of Comparative Examples. There were no occurrences of crystallization in Examples, while crystallization occurred in the Comparative Examples. Tables 1 and 2 summarize the conditions at the step of adding a cladding region for the respective Examples and Comparative Examples shown in FIG. 6.

TABLE I

| | Average Concentration of | Heating time | |
|---|---|---|---|
| | Potassium atm ppm | hour | Ratio d₂/d₁ |
| Example 1 | 100 | 4 | 1.1 |
| Example 2 | 100 | 2 | 1.2 |
| Example 3 | 100 | 7 | 1.5 |
| Example 4 | 100 | 10 | 1.7 |
| Example 5 | 100 | 16 | 1.9 |
| Example 6 | 100 | 30 | 2.5 |
| Example 7 | 300 | 3 | 1.2 |
| Example 8 | 300 | 4 | 1.3 |
| Example 9 | 300 | 5.5 | 1.5 |
| Example 10 | 300 | 15 | 2.2 |
| Example 11 | 300 | 18 | 2.5 |
| Example 12 | 300 | 20 | 3.0 |
| Example 13 | 1000 | 0.5 | 1.2 |
| Example 14 | 1000 | 1 | 1.5 |
| Example 15 | 1000 | 5 | 2.2 |
| Example 16 | 1000 | 7 | 2.5 |
| Example 17 | 1000 | 15 | 3.3 |
| Example 18 | 1000 | 25 | 4.0 |
| Example 19 | 3000 | 0.35 | 1.2 |
| Example 20 | 3000 | 0.7 | 1.5 |
| Example 21 | 3000 | 3 | 2.5 |
| Example 22 | 3000 | 5 | 3.3 |
| Example 23 | 3000 | 10 | 4.0 |
| Example 24 | 3000 | 20 | 4.7 |

TABLE II

| | Average | | |
|---|---|---|---|
| | Concentration of | | |
| | Potassium | Heating time | |
| | atm ppm | hour | Ratio d₂/d₁ |
| Comparative Example 1 | 100 | 4 | 1.0 |
| Comparative Example 2 | 100 | 8 | 1.2 |
| Comparative Example 3 | 100 | 13 | 1.5 |
| Comparative Example 4 | 100 | 17 | 1.6 |
| Comparative Example 5 | 100 | 25 | 1.9 |
| Comparative Example 6 | 100 | 30 | 2.0 |
| Comparative Example 7 | 300 | 3 | 1.0 |
| Comparative Example 8 | 300 | 6 | 1.3 |
| Comparative Example 9 | 300 | 12 | 1.5 |
| Comparative Example 10 | 300 | 17 | 2.2 |
| Comparative Example 11 | 300 | 20 | 2.5 |
| Comparative Example 12 | 300 | 25 | 3.0 |
| Comparative Example 13 | 1000 | 1 | 1.2 |
| Comparative Example 14 | 1000 | 2 | 1.5 |
| Comparative Example 15 | 1000 | 5 | 1.8 |
| Comparative Example 16 | 1000 | 12 | 2.3 |
| Comparative Example 17 | 1000 | 15 | 2.5 |
| Comparative Example 18 | 1000 | 18 | 3.0 |
| Comparative Example 19 | 3000 | 0.5 | 1.2 |
| Comparative Example 20 | 3000 | 2 | 1.7 |
| Comparative Example 21 | 3000 | 5 | 2.5 |
| Comparative Example 22 | 3000 | 12 | 3.5 |
| Comparative Example 23 | 3000 | 15 | 3.9 |
| Comparative Example 24 | 3000 | 20 | 4.2 |

FIG. 5, Table 1, and Table 2 indicate that the crystallization occurs in a shorter heating time when the potassium concentration is higher in the case where the ratio (d₂/d₁) of the diameter d₂ of the second core region 22 to the diameter d₁ of the first core region 21 is equal. It is also known that the larger the ratio (d₂/d₁), the less the crystallization occurs even if the heating time is long.

FIG. 6 is a graph showing the relationship between the attenuation of an optical fiber and the ratio (d₂/d₁) of the diameter d₁ of the first core region to the diameter d₂ of the second core region. Table 3 summarizes the respective relations between the attenuation of optical fibers and the ratio (d₂/d₁), wherein d₂ is the diameter of the second core region 22 and d₁ is the diameter of the first core region 21, in the Examples shown in FIG. 6. Note that the attenuation values of the optical fibers are those in the case of 1550 nm wavelength.

TABLE III

| | Average Concentration | | Attenuation |
|---|---|---|---|
| | of Potassium atm ppm | Ratio d₂/d₁ | dB/km |
| Example 31 | 100 | 1.0 | 0.168 |
| Example 32 | 100 | 1.2 | 0.168 |
| Example 33 | 100 | 1.5 | 0.170 |
| Example 34 | 100 | 1.6 | 0.172 |
| Example 35 | 100 | 1.9 | 0.173 |
| Example 36 | 100 | 2.0 | 0.177 |
| Example 37 | 300 | 1.0 | 0.165 |
| Example 38 | 300 | 1.3 | 0.167 |
| Example 39 | 300 | 1.5 | 0.167 |
| Example 40 | 300 | 2.2 | 0.169 |
| Example 41 | 300 | 2.5 | 0.173 |
| Example 42 | 300 | 3.0 | 0.180 |
| Example 43 | 1000 | 1.2 | 0.161 |
| Example 44 | 1000 | 1.5 | 0.162 |
| Example 45 | 1000 | 1.8 | 0.166 |
| Example 46 | 1000 | 2.3 | 0.170 |
| Example 47 | 1000 | 2.5 | 0.173 |
| Example 48 | 1000 | 3.0 | 0.178 |
| Example 49 | 3000 | 1.2 | 0.150 |
| Example 50 | 3000 | 1.5 | 0.152 |
| Example 51 | 3000 | 2.5 | 0.154 |
| Example 52 | 3000 | 3.3 | 0.160 |
| Example 53 | 3000 | 4.0 | 0.165 |
| Example 54 | 3000 | 4.7 | 0.168 |

As can be seen from FIG. 6 and Table 3, in the case where the average potassium concentration of the first core region 21 is 100 atm-ppm at the time of fabricating the first core region 21, the attenuation is less than 0.180 dB/km when the ratio (d₂/d₁) is 2.5 or less.

Even if the ratio (d₂/d₁) is large, the higher the potassium concentration of the first core region 21, the less degraded the attenuation is. However, even if the average potassium concentration of the first core region 21 is 1000 atm-ppm, the attenuation becomes as high as nearly 0.180 dB/km when the ratio (d₂/d₁) is larger than 3.5. This is because the attenuation became worse as the occupying ratio of the second core region 22 (the portion having a low Cl density) became higher with respect to the core region 20 as a result of increase in the ratio (d₂/d₁).

On the other hand, in the case where the ratio (d₂/d₁) is 2.5 or less, it is possible to make the attenuation below 0.180 dB/km, which is an average attenuation of a pure silica core fiber that is not doped with potassium, even if the average potassium concentration at the time of fabricating the first core region 21 is as low as 100 atm-ppm. Also, even when the ratio (d₂/d₁) is 2.5 and the average potassium concentration is as high as 1000 atm-ppm at the time of fabricating the first core-region 21, the crystallization can be restrained by making the heating time to be not longer than 7 hours at a temperature of 1200° C. or higher. Furthermore, even if the average potassium concentration at the time of fabricating the first core region 21 is as high as 3000 atm-ppm, the crystallization can be restrained by reducing the heating time at 1200° C. or higher to 3 hours or less, and with the ratio (d₂/d₁)=2.5, the attenuation of 1550 nm wavelength can be decreased to 0.154 dB/km.

Therefore, it is desirable to carry out the step of adding a cladding region by limiting the heating time at a temperature of 1200° C. or higher to 7 hours or less using the rod-in-collapse method, that is, a core rod is inserted into a pipe for cladding and is subsequently integrated with the pipe (collapsing). For forming a cladding region with the rod-in-collapse method, the rod-in-collapse processing may be performed by separating into two or more steps, provided that the heating time should be not more than 7 hours in total.

By manufacturing an optical fiber preform 10 in the above-mentioned manner, it is possible to isolate an alkali metal and a Cl element from each other in the optical fiber preform 10 and suppress formation of an alkali metal chloride. Thus, when an optical fiber is made by drawing the optical fiber preform, it is possible to suppress occurrences of fiber breakage and fluctuation in the diameter of the optical fiber. Furthermore, it is possible to avoid local degradation of attenuation of the optical fiber, and consequently optical fibers having low attenuation can be manufactured with high yield.

It can be seen that by shortening the heating time at temperatures of 1200° C. or higher to one hour, the ratio (d₂/d₁) can be lowered to 1.5 and the attenuation can be reduced to 0.162 dB/km. Furthermore, it can be seen that by shortening the time of heating at a temperature of 1200° C. or higher to half an hour or less, the ratio (d₂/d₁) can be lowered to 1.2, and the attenuation can be reduced to 0.161 dB/km. Therefore, the ratio (d₂/d₁) of the diameter d₂ of the second core region 22 to the diameter d₁ of the first core region 21 is preferably 1.2 or more and 2.5 or less, and the heating time at temperatures of 1200° C. or more is preferably 7 hours or less, more preferably 1 hour or less, and still more preferably half an hour or less.

Moreover, in the above-mentioned case, the ratio of cross-sectional area of the first core region 21 to the whole core region 20 was 1:20, and the average potassium concentration of the whole core region 20 in the optical fiber preform was 1/20 of the potassium concentration of the first core region 21. That is, the average potassium concentration of the whole core region 20 was about 5 atm-ppm when the average potassium concentration of the first core region 21 was 100 atm-ppm at the time of production.

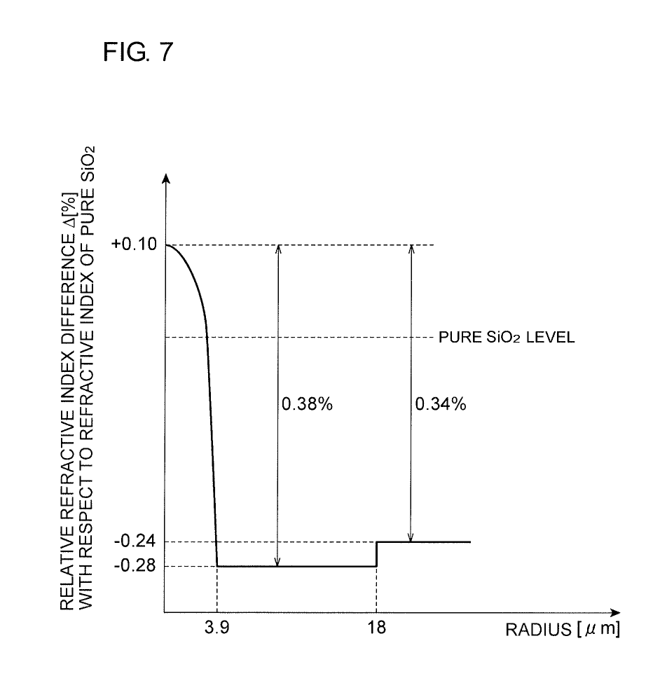

FIG. 7 is a conceptional schematic diagram showing the refractive index profile of the optical fibers fabricated by drawing optical fiber preforms prepared by the above-described manufacturing method. The optical characteristics of the optical fibers were as shown in Table IV.

TABLE IV

| | | |
|---|---|---|
| Chromatic dispersion @1550 nm | ps/nm/km | 15.5 to 16.2 |
| Dispersion slope @1550 nm | ps/nm²/km | 0.052 to 0.054 |
| Zero dispersion wavelength d₀ | nm | 1307 to 1315 |
| Dispersion slope @ d₀ | ps/nm²/km | 0.080 to 0.083 |
| A_{eff} @ 1550 nm | μm² | 78 to 84 |
| MFD @1550 nm | μm | 9.9 to 10.6 |
| MFD @1310 nm | μm | 8.8 to 9.5 |
| Fiber cut-off wavelength (2 m fiber) | nm | 1280 to 1340 |
| Cable cut-off wavelength (22 m fiber) | nm | 1190 to 1250 |
| PMD in C and L bands | ps/√km | 0.04 to 0.12 |
| Non-linear coefficient | (W km)⁻¹ | 0.9 to 1.1 |
| random dispersion state, @1550 nm, | | |

As shown in the above, optical fibers with low attenuation were obtained.

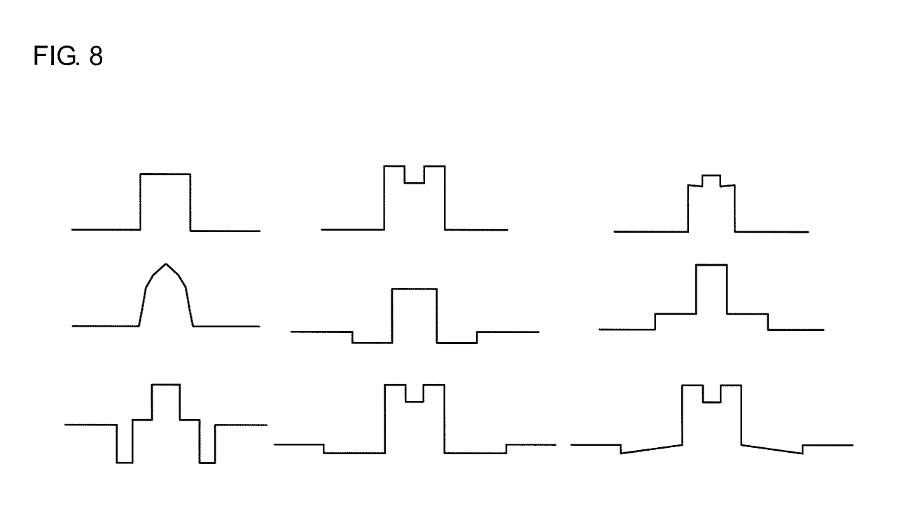

The diameter of the core region 20 may be 6 to 20 μm, and the relative refractive index difference between the core region 20 and the cladding region 30 may be 0.2 to 0.5%. The attenuation will be less in the case of a silica-based glass as follows: fluorine is added to the cladding region 30, the average refractive index of the cladding region 30 is lower than that of the core region 20, and halogen (Cl and F) and alkali metal are added to the core region 20, such that the density of halogen is the highest of densities of doped elements. The core region 20 and the cladding region 30 may, for example, have a refractive-index profile, such profiles as shown in FIG. 8, but not limited to them. The higher the potassium density, the more increase in the loss due to radiation irradiation occurs, and the maximum of potassium concentration is most preferably 500 atm-ppm.

What is claimed is:

1. A method of manufacturing an optical fiber preform having a core region including a central axis and a cladding region formed around the core region, the refractive index of the cladding region being lower than that of the core region, the method comprising:
a step of preparing a core rod having a first core region with Cl density of less than 600 atm-ppm and including the central axis, a second core region with Cl density of less than 600 atm-ppm and formed around the first core region, and a third core region with CI density of 3000 atm-ppm or more and formed around the second core region, wherein an alkali metal is selectively added to the first core region among the first, second, and third core regions; and
a step of adding a cladding region around the core rod by heating at a temperature of not less than 1200° C. for 7 hours or less.

2. A method of manufacturing an optical fiber preform according to claim 1, wherein
the ratio (d₂/d₁) of a diameter d₂ of the second core region to a diameter d₁ of the first core region is 1.2 or more and 2.5 or less.

3. A method of manufacturing an optical fiber preform according to claim 2, wherein
the ratio (d₂/d₁) is 1.5 or more and 2.5 or less.

4. A method of manufacturing an optical fiber preform according to claim 1, wherein
the heating time at temperatures of 1200° C. or more is 1 hour or less at the step of adding a cladding region.

5. A method of manufacturing an optical fiber preform according to claim 1, wherein
at the step of adding a cladding region, the cladding region is provided around the core rod in such a manner as to insert the core rod into a silica glass pipe and integrate the core rod and the silica glass pipe.
